(19) United States
(12) Patent Application Publication
(10) Pub. No.: US 2024/0244446 A1
(43) Pub. Date: Jul. 18, 2024

(54) SYSTEMS AND METHODS FOR UE TRIGGERED ON/OFF STATUS CONTROL FOR NETWORK NODES

(71) Applicant: ZTE Corporation, Shenzhen (CN)

(72) Inventors: Ziyang LI, Shenzhen (CN); Nan ZHANG, Shenzhen (CN); Wei CAO, Shenzhen (CN); Hanqing XU, Shenzhen (CN); Jian LI, Shenzhen (CN)

(73) Assignee: ZTE Corporation, Shenzhen (CN)

(21) Appl. No.: 18/617,132

(22) Filed: Mar. 26, 2024

Related U.S. Application Data
(63) Continuation of application No. PCT/CN2022/100837, filed on Jun. 23, 2022.

(51) Int. Cl. H04W 16/26; H04B 7/155

(52) U.S. Cl. CPC H04W 16/26; H04B 7/15507

(57) ABSTRACT

Presented are systems and methods for user equipment (UE) triggered on/off status control for network nodes. A network node can receive a signal from a wireless communication device. The network node can determine, in connection with the signal, an on/off state of the network node to support signal forwarding of one or more signals between a wireless communication node and the wireless communication device.

### CROSS-REFERENCE TO RELATED APPLICATION

This application claims the benefit of priority under 35 U.S.C. § 120 as a continuation of PCT Patent Application No. PCT/CN2022/100837, filed on Jun. 23, 2022, the disclosure of which is incorporated herein by reference in its entirety.

### TECHNICAL FIELD

The disclosure relates generally to wireless communications, including but not limited to systems and methods for user equipment (UE) triggered on/off status control for network nodes.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can receive a signal from a wireless communication device (e.g., user equipment (UE)) (e.g., while operating in a monitoring state). The network node can determine, in connection with the signal, an on/off state (e.g., or configuration) of the network node to support signal forwarding of one or more signals between a wireless communication node (e.g., base station (BS)) and the wireless communication device.

In some implementations, to determine the on/off state in connection with the signal, the network node can determine the on/off state using or according to the signal. In some cases, the network node can send a first message to the wireless communication node according to the signal. In this case, the network node can receive a second message from the wireless communication node in response to the first message. The network node can determine the on/off state of the network node according to the second message.

In some implementations, the network node can receive an indication of at least one of: a start time, a pattern, a Start and Length Indicator Value (SLIV), a duty cycle, a time offset, a duration or a periodicity, of a monitoring state of the network node from the wireless communication node. The network node can operate in the monitoring state to monitor the signal from the wireless communication device. The indication can be received via at least one of: an operations, administration and maintenance (OAM) signal, a system information (SI) signal, a radio resource control (RRC) signal, a downlink control information (DCI) signal, or a medium access control control element (MAC CE) signal.

In some implementations, the network node can receive an indication from the wireless communication node. The indication can include or indicate at least one of: a start time, a pattern, a SLIV, a duty cycle, a time offset, a duration, a periodicity, a frequency domain indicator, a frequency offset, or a resource block (RB) number, of a time or frequency domain resource of the network node. The network node can monitor in the time or frequency domain resource to monitor the signal from the wireless communication device. The indication can be received via at least one of: an operations, administration and maintenance (OAM) signal, a system information (SI) signal, a radio resource control (RRC) signal, a downlink control information (DCI) signal, or a medium access control control element (MAC CE) signal. In some implementations, the on/off state (e.g., or configuration) can comprise at least one of: an on/off state of the network node; an on/off state of a group of network nodes; an on/off state of one or more antenna ports of the network node; an on/off state of one or more beam indexes of the network node; an on/off state of one or more serving sectors of the network node; or an on/off state of one or more components of the network node. In some implementations, the on/off state can further comprise the on/off state of at least one of following links: a first control link from the wireless communication node to the network node; a second control link from the network node to the wireless communication node; a first backhaul link from the wireless communication node to the network node; a second backhaul link from the network node to the wireless communication node; a first access link from the network node to the wireless communication device; or a second access link from the wireless communication device to the network node.

In some implementations, the wireless communication device can receive an indication from the wireless communication node. The indication can include at least one of: a start time, a pattern, a Start and Length Indicator Value (SLIV), a duty cycle, a time offset, a duration or a periodicity, of a probing state of the wireless communication device. The wireless communication device can operate in the probing state to transmit the signal to the network node. The indication can be received via at least one of: a system information (SI) signal, a radio resource control (RRC) signal, a downlink control information (DCI) signal, and/or a medium access control control element (MAC CE) signal.

In some implementations, the wireless communication device can receive an indication from the wireless communication node. The indication can include at least one of: a start time, a pattern, a SLIV, a duty cycle, a time offset, a duration, a periodicity, a frequency domain indicator, a frequency offset, a resource block (RB) number, of the time or frequency domain resource of the wireless communication device. The wireless communication device can transmit in the time or frequency domain resource the signal to the network node. The indication can be received via at least one of: a system information (SI) signal, a radio resource control (RRC) signal, a downlink control information (DCI) signal, and/or a medium access control control element (MAC CE) signal.

In some implementations, the wireless communication device can determine whether to trigger the network node to support the signal forwarding according to at least one of: a measurement of a reference signal received power (RSRP) of a synchronization signal block (SSB), a random access failure, a physical uplink control channel (PUCCH) transmission failure, and/or a physical uplink shared channel (PUSCH) transmission failure occurring for a defined number of times. In various implementations, the wireless communication device can receive a parameter from the wireless communication node for determining whether to enable a functionality (e.g., or capability) of sending a signal to trigger the on/off state of network node.

In some implementations, the signal can include at least one of: a preamble to configure the wireless communication device for initial access, a preamble to configure the wireless communication device, dedicated to enabling a change to the on/off state of the network node, a msg3 or a MsgA physical uplink shared channel (PUSCH), a reference signal (RS), a configured uplink transmission of a configured grant SDT (CG-SDT), a dedicated PUCCH transmission, a defined MAC CE signal in PUSCH, and/or a dedicated signal or data sequence. The RS can comprise at least one of: a sounding reference signal (SRS), a demodulation reference signal (DMRS), or a phase tracking reference signal (PTRS). The RS can be transmitted with a dedicated port index.

In some implementations, the network node may send an indication of the on/off state, in an uplink control information (UCI) signal via a physical uplink control channel (PUCCH) or a physical uplink shared channel (PUSCH), or in a medium access control control element (MAC CE) signal via the PUSCH to the wireless communication node.

In some implementations, the wireless communication node may transmit system information directly to at least the wireless communication device, or via the network node to at least the wireless communication device after receiving the indication of the on/off state. The system information can indicate that one or more links of the network node is turned on.

At least one aspect is directed to a system, method, apparatus, or a computer-readable medium. A wireless communication device (e.g., UE) can send the signal to a network node (e.g., SN). The network node can determine an on/off state of the network node in connection with the signal to support signal forwarding of one or more signals between a wireless communication node and the wireless communication device.

The systems and methods presented herein include a novel approach for on/off status control for network nodes. Specifically, the systems and methods presented herein discuss a novel solution for using the network node (e.g., SN) to improve coverage of the network and improve efficiency of the SN by various implementations of the on/off indication(s) triggered by the user equipment (UE). For example, the SN (e.g., operating in an on/off monitoring state/status/condition) can receive a signal from the UE to activate/enable/initiate at least one of the forwarding link or functionality of the SN. Hence, the SN can determine the on/off state (or configuration) of the network node according to the received signal to support signal forwarding of one or more signals between the wireless communication node (e.g., BS) and the UE.

In some cases, the SN is in the on/off monitoring state or provided with a time or frequency domain resource, which the communication unit of the SN can continuously or keep monitoring an uplink (UL) signal from the UE. For example, the UE can be in at least the following state/condition: RRC_IDLE state, RRC_INACTIVE state, or RRC_CONNECTED state. When the UE is in one of the states, the SN may be transparent to the UE or may be non-transparent to the UE. When the SN is transparent to the UE, the characteristic/behavior/functionality of the UE can be similar to legacy. For example, the UE may not know or may not be aware of the presence of the SN, and the UE can (e.g., attempt to) transmit the signal to the BS (e.g., gNB or wireless communication node). When the SN communication unit (CU) detects the UL signal from the UE, the SN can activate/enable at least one of the forwarding link and/or functionality of the SN to ensure proper UL transmission to the BS, for example. When the SN is non-transparent to the UE, the UE can be aware of the SN. Hence, for example, the UE can transmit/send/communicate a dedicated signal to the SN to trigger the activation of at least one of forwarding link and/or functionality of the SN.

When the UE is in RRC_IDLE state, and the SN is transparent to the UE, the UE may initiate a random access procedure and transmit/signal a preamble (e.g., RRC establishment, scheduling request (SR), buffer status report (BSR), beam failure recovery, handover, and/or SI request, etc.). When the SN receives the preamble, the SN can activate/turn on a forwarding link to ensure the coverage of the UE (e.g., amplifies the signal of the UE or forward the signal to the BS via the forwarding link). When the UE is in RRC_IDLE state, and the SN is non-transparent to the UE, the UE may transmit at least one of a preamble, a reference signal (RS), and/or a dedicated sequence to the SN.

When the UE is in RRC_INACTIVE state, and the SN is transparent to the UE, the UE may transmit a preamble, sounding reference signal (SRS), and/or small data transmission (SDT) in an inactive state. In this case, the on/off monitoring state of the SN can cover/support the random access channel (RACH) occasion and/or UE-specific configured grant SDT (CG-SDT) occasion. When the UE is in RRC_INACTIVE state, and the SN is non-transparent to the UE, the UE may determine/decide to control the on/off status of SN according to the coverage level, for example, by transmitting a signal including at least one of a preamble, SRS, SDT, and/or dedicated sequence to the SN during the on/off monitoring state.

When the UE is in RRC_CONNECTED STATE, and the SN is non-transparent to the UE, the UE can be provided/indicated with at least one of a start time, a pattern, a Start and Length Indicator Value (SLIV), a duty cycle, a time offset, a duration or a periodicity, of a probing state of the wireless communication device through at least one of a System information (SI) signal, a radio resource control (RRC) signal, a downlink control information (DCI) signal, and/or a medium access control control element (MAC CE) signal. For example, when the UE encounters/experiences a coverage problem/issue, the UE may determine/decide to turn on the SN forwarding link. The decision criteria/condition to turn on the SN forwarding link can include at least one of: random access failure for handover, physical uplink control channel (PUCCH) transmission failure, and/or physical uplink shared channel (PUSCH) transmission failure for N times. In some cases, the UE may decide to control the on/off status of the SN according to or based on the coverage level by transmitting a signal including at least one of a preamble, RS, dedicated sequence, PUCCH, and/or PUSCH to the SN (e.g., during the on/off monitoring state). After the SN forwarding link or functionality is activated, the SN may report/indicate the SN-UE serving relationship to the BS. The information indicating the SN-UE serving relationship can be included/embedded in an uplink control information (UCI) signal carried by PUCCH or PUSCH, or in MAC CE carried by PUSCH.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of an example network, in accordance with some embodiments of the present disclosure;

FIG. 4 illustrates a schematic diagram of transmission links between BS to SN and SN to UE, in accordance with some embodiments of the present disclosure;

FIG. 5 illustrates a tree diagram of various options for activating the forwarding link or functionality of the SN, in accordance with some embodiments of the present disclosure;

FIG. 6 illustrates an example of the probing state of the UE and the monitoring state of the SN;

FIG. 7 illustrates another example of the probing state of the UE and the monitoring state of the SN;

FIG. 8 illustrates a flow diagram of examples procedures for the SN receiving the signal from the UE and/or the BS; and

FIG. 9 illustrates a flow diagram of an example method for UE triggered on/off status control for network nodes, in accordance with an embodiment of the present disclosure.

### DETAILED DESCRIPTION

### 1. Mobile Communication Technology and Environment

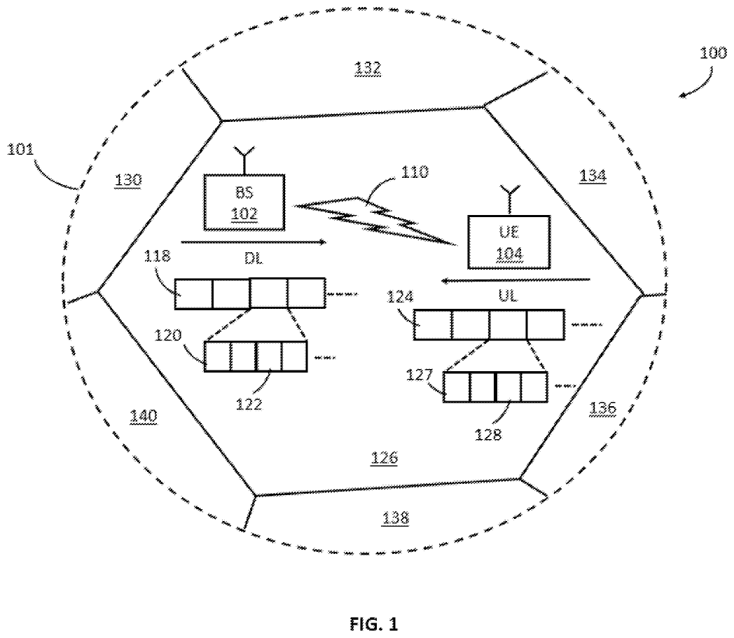

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

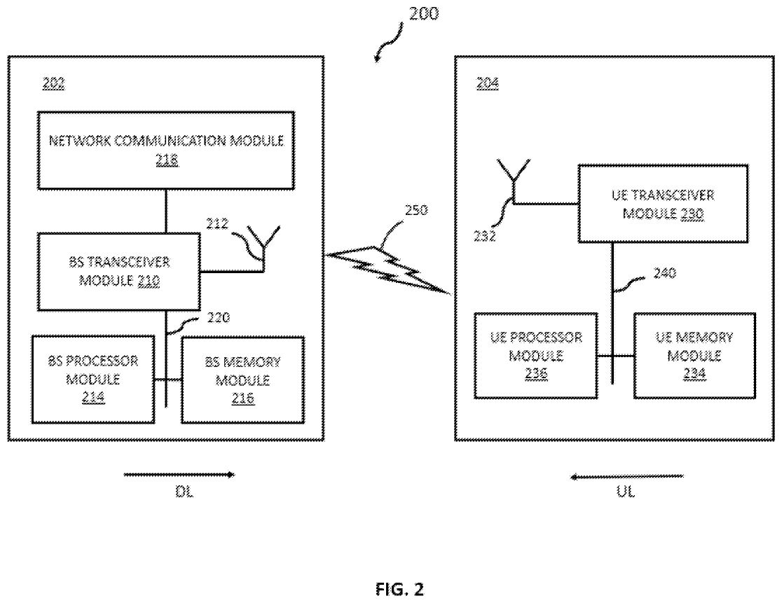

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communicate with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for UE Triggered On/Off Status Control for Network Nodes

In certain systems (e.g., 5G new radio (NR), Next Generation (NG) systems, 3GPP systems, and/or other systems), a network-controlled repeater can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration.

The network-controlled repeater (NCR) can be regarded as a stepping stone of a re-configurable intelligent surface (RIS). A RIS node can adjust the phase and amplitude of the received signal to improve/enhance the coverage (e.g., network communication coverage). As discussed herein, network nodes, including and not limited to network-controlled repeater, smart repeater, Re-configuration intelligent surface (RIS), Integrated Access and Backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.). However, due to the SNs not being aware of other SNs, the UE 104 may suffer from interference from other SNs, such as for cell-edge UEs.

To mitigate/minimize/reduce the (e.g., unexpected) interference from other SNs, the systems and methods of the technical solution discussed herein can introduce/provide/leverage an on/off status control. With the on/off status control, the network (e.g., the BS 102) can explicitly or implicitly indicate/provide the on/off status/indication for one or more SNs, thereby alleviating the potential impact of interference during communication between the BS 102 and the UE 104 through one or more SNs (e.g., network nodes). For instance, as discussed herein, the on/off controls can be triggered by the UE 104 with one or more SNs being transparent or non-transparent to the UE 104.

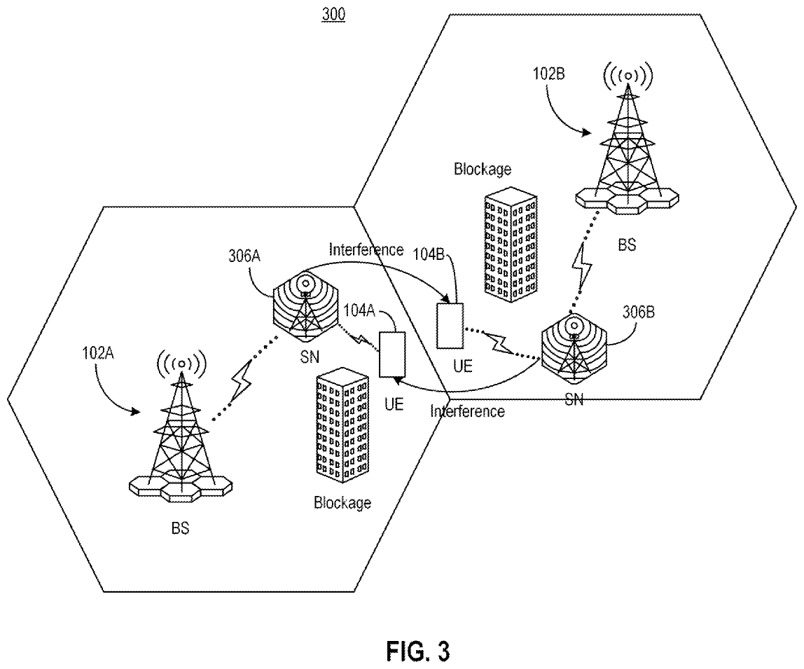

FIG. 3 illustrates a schematic diagram of an example network 300. As illustrated in FIG. 3, one or more BSs 102A-B (e.g., BSs 102) can serve one or more UEs 104A-B (e.g., UEs 104) respectively in their cells via the respective one or more SNs 306A-B (e.g., sometimes labeled as SN(s) 306), such as when there are blockages between the BS(s) 102 and the UE(s) 104. However, in some cases, the signals from an SN 306 may interfere with the communications in an adjacent cell. For example, signals from SN 306A may interfere with the communications in the cell associated with UE 104B, and/or signals from SN 306B may interfere with the communications in the cell associated with UE 104A. As such, the systems and methods discussed herein can utilize the on/off status control for the SNs to minimize at least the interferences by the signals of the SNs 306 between different cells.

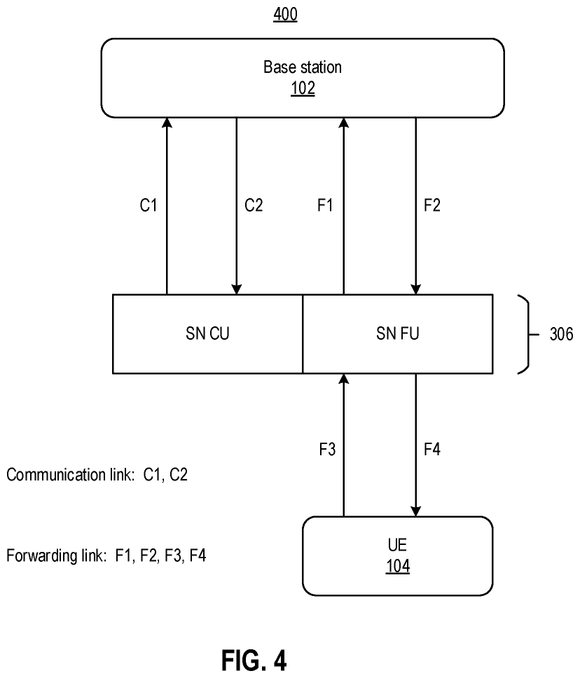

FIG. 4 illustrates a schematic diagram 400 of transmission links between BS 102 to SN 306 and SN 306 to UE 104. The SN 306 can include or consist of at least two functional parts/components, such as the communication unit (CU) (e.g., SN CU) and the forwarding unit (FU) (e.g., SN FU). For example, the SN CU can be a network-controlled repeater (NCR) MT. In another example, the SN FU can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on.

The transmission links between the BS 102 to SN 306 and the SN 306 to UE 104 as shown in FIG. 4 can be defined/described/provided as follows:
C1: Control link from SN CU to BS;
C2: Control link from BS to SN CU;
F1: Backhaul link from SN FU to BS;
F2: Backhaul link from BS to SN FU;
F3: Access link from UE to SN FU; and
F4: Access link from SN FU to UE.

Control link (e.g., sometimes referred to as a communication link) can refer to or mean that the signal from one side will be detected and decoded by the other side, so that the information transmitting in the control link can be utilized to control the status of forwarding links (e.g., backhaul links and/or access links). Forwarding link can mean that the signal from BS 102 or UE 104 is unknown to SN FU. In this case, the SN FU can amplify and forward signals without decoding them. For example, the F1 and F3 links can correspond to or be associated with the complete uplink (UL) forwarding link (e.g., backhaul link and access link, respectively) from UE 104 to BS 102, in which F1 is the SN FU UL forwarding link. Additionally, the F2 and F4 links can correspond to or be associated with the complete DL forwarding link (e.g., backhaul link and access link, respectively) from BS 102 to UE 104, in which F4 is the SN FU DL forwarding link. The F1 and F2 links can correspond to or be referred to as backhaul links and F3 and F4 links can correspond to or be referred to as access links.

Example Implementation: SN (e.g., in on/Off Monitoring State) to Receive Signal from the UE to Activate the Forwarding Link or Functionality of the SN

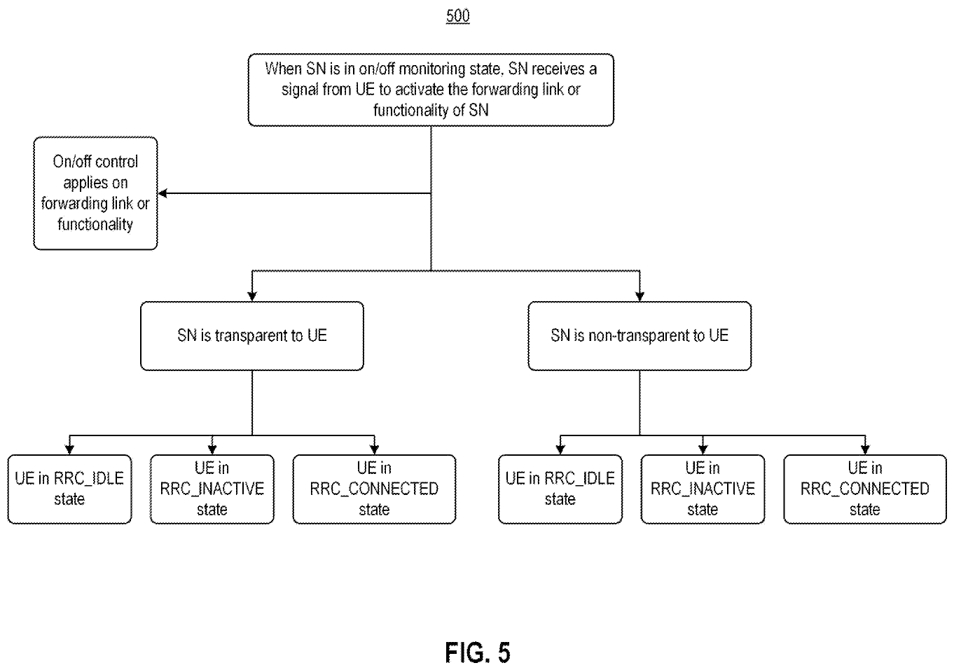

Referring to FIG. 5, depicted is a tree diagram 500 of various options for activating the forwarding link or functionality of the SN 306. In various implementations, the forwarding link of the SN 306 may be off/deactivated/disabled. The SN 306 can be in an on/off monitoring state (e.g., a state where the SN CU can keep/continue monitoring a UL signal/transmission from the UE 104) or provided with a time and/or frequency domain resource for monitoring (e.g., in this time and/or frequency domain resource, SN CU can keep/continue monitoring a UL signal/transmission from the UE 104).

The SN 306 can be indicated or receive/obtain an indication from the BS 102 of at least one of a start time, a pattern, a Start and Length Indicator Value (SLIV), a duty cycle, a time offset, a duration or a periodicity to configure the on/off monitoring state of the SN 306. The SN 306 can receive the indication via/through at least one of an operations, administration and maintenance (OAM) signal, a system information (SI) signal, a radio resource control (RRC) signal, a downlink control information (DCI) signal, and/or a medium access control control element (MAC CE) signal.
1) Through OAM signal, the parameters (e.g., duration and/or periodicity) indicated to the SN 306 can be configured by the network (e.g., BS 102) via the OAM.
2) Through SI signal, the parameters can be configured by the BS 102 via SI.
   a. In this case, the configuration of on/off monitoring state of the SN 306 can be the same for all SNs 306 in a cell.
3) Through RRC signal, these new RRC parameters will be defined, a value or a set of values can be configured through RRC message.
4) Through DCI signal, one or more new DCI fields can be defined/configured, or at least one existing DCI field can be re-interpreted/reconfigured/re-defined.
5) Through MAC CE signal, at least one new MAC CE can be defined, such as SN monitoring MAC CE.
6) Through RRC and DCI signals, at least one set of values for each of the parameters can be configured in an RRC message/signal, and/or at least one of the sets of values can be activated/enabled by the DCI signal.
7) Through RRC and MAC CE signals, at least one set of values for each of the parameters can be configured in the RRC message, and/or at least one of the sets of values can be activated by the MAC CE signal.
8) Through RRC, MAC CE, and DCI signals, at least one set of values for each of the parameters can be configured in the RRC message, a subset/portion of the values may be selected by or according to the MAC CE signal, and/or at least one of the subsets of values can be activated by the DCI signal.
9) Through OAM and DCI signals, the parameters can be configured by the BS 102 via the OAM signal. In some cases, one or more values of the parameters can be updated by the DCI signal.
10) Through OAM and MAC CE signals, the parameters can be configured by the BS 102 via OAM signal. In some cases, one or more values of the parameters can be updated by the MAC CE signal.

In various implementations, the SN 306 may be transparent or non-transparent to the UE 104. For example, if the SN 306 is transparent to UE 104, the behavior/characteristic/operations of the UE 104 can be similar to legacy. In this case, the UE 104 may transmit/send/communicate/provide a signal (e.g., directly) to BS 102 because the UE 104 may not be aware of the SN 306. During the transmission, the SN CU may detect/intercept the UL signal from the UE 104. Accordingly, the SN 306 may activate at least one forwarding link and/or at least one functionality of the SN 306 to ensure proper UL transmission based on the UL signal. In another example, if the SN 306 is non-transparent to the UE 104, the UE 104 can transmit/communicate at least one dedicated signal to the SN 306 to trigger the activation of the forwarding link or functionality of the SN 306.

The UE triggered on/off status control (e.g., activation and/or deactivation of forwarding links, among other links) can apply, be configured for, or utilized on at least one of the following links:
F1: Forwarding link from SN FU to BS 102;
F2: Forwarding link from BS 102 to SN FU;
F3: Forwarding link from UE 104 to SN FU; and/or
F4: Forwarding link from SN FU to UE 104.

The UE triggered on/off status control may apply on at least one of the following forwarding functionality:
Fc1: Forwarding functionality from SN FU to BS 102;
Fc2: Forwarding functionality from BS 102 to SN FU;
Fc3: Forwarding functionality from UE 104 to SN FU; and/or
Fc4: Forwarding functionality from SN FU to UE 104.

### Example: UE in RRC_IDLE State

In some implementations, the UE may be in an RRC_IDLE state (e.g., sometimes referred to as an idle state). In various implementations discussed herein, the state of the UE 104 can be indicated/provided to the SN 306. In some cases, the state of the UE 104 may not be provided to the SN 306. The SN 306 may be transparent or non-transparent to the UE 104. For example, if the SN 306 is transparent to the UE 104 (e.g., legacy behavior), the UE 104 may initiate a random access procedure. Responsive to or concurrent to the initiation of the random access procedure, the UE 104 can transmit a signal to the SN 306. The signal can include a preamble (e.g., sometimes referred to as msg1), msg3 or msgA PUSCH (e.g., for RRC establishment, scheduling request (SR), buffer status report (BSR), beam failure recovery, handover, and/or SI request), among other types of signals for random access procedures. Subsequent to the SN 306 receiving/intercepting/obtaining the preamble, msg3 or msgA PUSCH, the SN 306 can determine the on/off state (e.g., sometimes referred to as on/off configuration), which may include turning on/activating/enabling/triggering one or more forwarding links to ensure the coverage or support for signal forwarding for the UE 104. The forwarding link can include at least one of a first backhaul link (e.g., F1 link) from the SN 306 to the BS 102, a second backhaul link (e.g., F2 link) from the BS 102 to the SN 306, a first access link (e.g., F3 link) from the UE 104 to the SN 306, and/or a second access link (e.g., F4 link) from the SN 306 to the UE 104. Hence, the preamble can indicate the on/off configuration of the forwarding link(s) of the SN 306.

In another example, if the SN 306 is non-transparent to the UE 104, the UE 104 may be indicated with or receive/obtain an indication of at least one of a start time, a pattern, a Start and Length Indicator Value (SLIV), a duty cycle, a time offset, a duration or a periodicity of UE probing state (e.g., sometimes referred to as triggering state). The UE 104 may also be indicated with or receive/obtain an indication of at least one of a start time, a pattern, a SLIV, a duty cycle, a time offset, a duration, a periodicity, a frequency domain indicator, a frequency offset, a resource block (RB) number, of the time or frequency domain resource. The UE 104 may be indicated via/through system information or configuration from at least one of the SN 306 and/or the BS 102, for example. Prior to or before initiating the random access procedure, the UE 104 can determine whether to trigger (e.g., turn on/activate/enable) the SN 306 to support signal forwarding (e.g., one or more forwarding links of the SN 306). The determination of whether to trigger can be based on or according to a measurement of a reference signal received power (RSRP) of a synchronization signal block (SSB), measured by the UE 104.

Upon determining to activate the SN forwarding link, the UE 104 can transmit/send/provide/communicate a signal to the SN 306. The signal can include at least one of a preamble (e.g., dedicated for the SN 306), an RS (e.g., at least one of SRS and/or DMRS, etc.) signal, and/or a (e.g., new) dedicated sequence. For example, the UE 104 may initiate a random access procedure with at least one dedicated preamble. The dedicated preamble can include a dedicated resource known by the SN 306 and the UE 104. The dedicated resource can include at least one of: a time domain resource of a physical random access channel (PRACH) occasion, a frequency domain resource of the PRACH occasion, and/or a preamble index. The preamble index can include or correspond to a logical index, which may be regarded or indicated as a type of code domain resource, for instance, preambles with different indexes may correspond to different cyclic shifts of a Zadoff-Chu (ZC) sequence. Further, the dedicated sequence may include or correspond to at least one of dedicated signal and/or data sequence. The dedicated sequence can correspond to at least one of on-off keying (OOK) sequence, computer-generated sequence (CGS), and/or low peak-to-average-power ratio (PAPR) sequence. The dedicated sequence can be used to simplify the signal detection, for instance, the signal detection can be processed in the time domain without additional time-frequency transition operation.

### Example: UE in RRC_INACTIVE State

In some implementations, the UE 104 can be in RRC_INACTIVE state (e.g., sometimes referred to as inactive state. The SN 306 may be transparent or non-transparent to the UE 104. For example, if the SN 306 is transparent to the UE 104 (e.g., legacy behavior), the UE 104 may initiate a random access procedure, such as to resume to/continue with/maintain a connected state. Subsequently, the UE 104 can transmit a signal to the SN 306. The signal can include at least one of a preamble, msg3 or MsgA PUSCH established by the random access procedure, an SRS, and/or small data transmission (SDT) in the inactive state. The UE 104 may trigger the SDT procedure to transmit configured grant SDT (CG-SDT) and/or random access SDT (RA-SDT) (e.g., transmitting the signal including a configured uplink transmission of CG-SDT and/or RA-SDT). In this case, the on/off monitoring state (e.g., triggering state) of the SN 306 can cover or support at least one of RACH occasion and/or UE-specific CG-SDT occasion.

The SN 306 can receive the signal (e.g., UL signal) from the UE 104 including at least one of the preamble, SRS, and/or SDT-related signals. After receiving the signal, the forwarding link of SN 306 can be turned on to ensure the coverage of or support for signal forwarding for the UE 104. For example, the received signal can include or correspond to the preamble, msg3 or MsgA PUSCH for normal random access procedure(s) (e.g., for RRC resume request, SR, BST, beam failure recovery, handover, and/or SI request). The signal can include or correspond to at least one of SRS, such as SRS for positioning when the UE 104 is in the inactive state. The signal can include or correspond to at least one of the preamble for RA-SDT, msg3 or MsgA PUSCH (e.g., including UE ID, etc.) for RA-SDT, and/or configured UL transmission for CG-SDT. Hence, in response to the signal, the SN 306 can determine the on/off configuration including triggering the SN 306 to support signal forwarding (e.g., at least one of the forwarding links).

In some cases, the SN 306 may be non-transparent to the UE 104. For example, if the SN 306 is non-transparent to the UE 104, the UE 104 can receive or be provided with an indication of at least one of a start time, a pattern, a Start and Length Indicator Value (SLIV), a duty cycle, a time offset, a duration or a periodicity of UE probing state (e.g., sometimes referred to as a triggering state) of the UE 104, and/or location or beam/spatial information of the SN 306. The UE 104 can receive the indication via at least one of: SI signal, a RRC signal (e.g., in RRC release message when the UE 104 enters the inactive state), a DCI signal, and/or a MAC CE signal, among others.

In some aspects, the UE 104 may experience/encounter/identify a coverage problem (e.g., via SSB measurement). The UE 104 may determine/decide to activate the SN forwarding link (e.g., support for signal forwarding by the SN 306), such as for purposes of initiating random access procedure, triggering SDT procedure, and/or positioning. The UE 104 may determine to control or trigger the on/off status/condition/state of the SN 306 based on or according to the coverage level. For example, the UE 104 can initiate a random access procedure (e.g., for SR, BSR, beam failure recovery, handover, and/or SI request). The UE 104 can transmit a signal in response to or subsequent to initiating the random access procedure. The signal can include at least one of a preamble, msg3 or msgA PUSCH established by the random access procedure, RS, SDT, and/or dedicated sequence to the SN 306 (e.g., during the on/off monitoring state). The preamble, msg3 or msgA PUSCH can be dedicated/configured to activate the SN 306 (e.g., support for signal forwarding), which can be known by the UE 104 and the SN 306. The RS of the signal can include at least one of SRS (e.g., for positioning in the inactive state), a demodulation reference signal (DMRS), and/or a phase tracking reference signal (PTRS). The UE 104 may trigger an SDT procedure to transmit at least one of CG-SDT and/or RA-SDT (e.g., including in the signal). For instance, the signal transmitted by the UE 104 can be triggered by or via the SDT procedure. The dedicated sequence can include or correspond to a dedicated signal and/or data sequence. The dedicated sequence can include or correspond to at least one of OOK sequence, CGS, and/or low PAPR sequence. The dedicated sequence may be used to simplify the signal detection. For example, the signal detection can be processed in the time domain without additional time-frequency transition operation. In this case, the received signal can be (e.g., directly) processed in the time domain, such that an inverse fast Fourier transform (IFFT) operation may not required, and/or the signal processing procedure can be simplified.

Accordingly, the SN 306 can receive the UL signal from the UE 104. The signal can include at least one of the preamble, SRS, SDT-related signal, and/or dedicated sequence. Responsive to the signal, the SN 306 can activate at least one forwarding link to support signal forwarding for the UE 104. In this case, the preamble can be for normal random access procedure. The SRS can be an SRS for positioning. The preamble can be for RA-SDT, msg3 or MsgA PUSCH for RA-SDT, and/or configured UL transmission for CG-SDT. The dedicated sequence can include at least one of OOK sequence, CGS, and/or low PAPR sequence.

### Example: UE in RRC_CONNECTED State

In various implementations, the UE 104 may be in a connected state. In this case, if the SN 306 is transparent to the UE 104, the signal from the UE 104 may be voided, ignored, or may not be intercepted by the SN 306. For instance, the SN 306 can determine, identify, or obtain the state of the UE 104 based on or according to the signal (e.g., SDT transmitted in an inactive state) from the UE 104. In some cases, if the state of the UE 104 is not provided to the SN 306, the SN 306 may determine whether to void the intercepted or received signal based on the types of information included in the signal (e.g., additional information compared to UE in idle state or inactive state). Otherwise, if the SN 306 is non-transparent, the signal from the UE 104 may not be voided.

When the SN 306 is non-transparent to the UE 104, the UE 104 can be provided with an indication of at least one of a start time, a pattern, a Start and Length Indicator Value (SLIV), a duty cycle, a time offset, a duration or a periodicity of UE probing state (e.g., sometimes referred to as a triggering state), and/or a location or beam/spatial information of the SN 306. The indication can be provided via at least one of system information, RRC, DCI, and/or MAC CE signals. The parameters for the UE 104 (e.g., for configuring the probing state of the UE 104) can be similar to or different from the parameters configured for the SN 306 (e.g., for configuring the monitoring state of the SN 306).

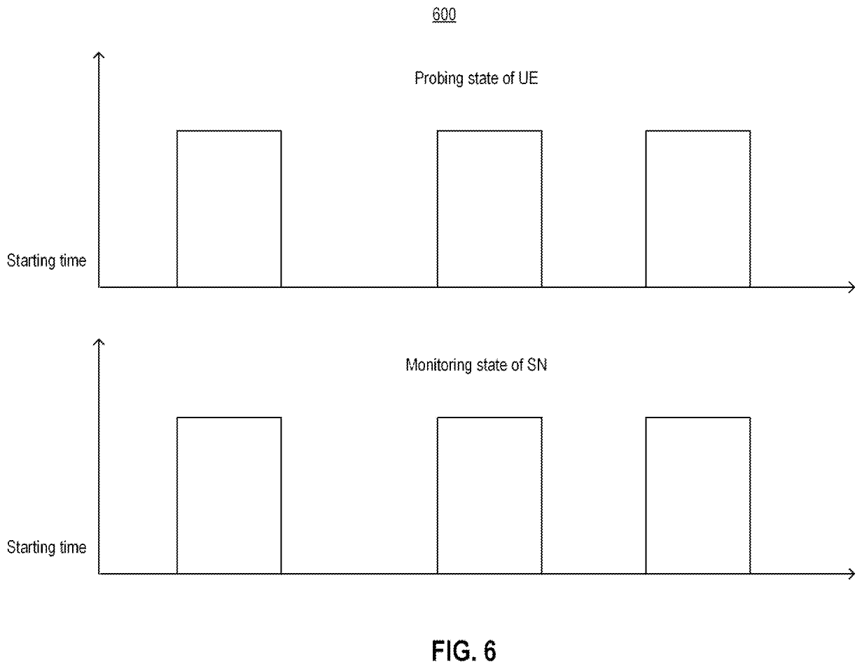

In some implementations, the probing state of the UE 104 can be similar to the monitoring state of the SN 306. For example, referring to FIG. 6, depicted is graph 600 of an example probing state of the UE and monitoring state of the SN 306. The time duration of the probing state and the monitoring state can be similar to one another. In this case, when the UE 104 is within the probing state, the UE 104 can transmit at least one signal to the SN 306 (e.g., in the monitoring state for the same time duration and instance as the probing state) for activation of one or more forwarding functionalities or links.

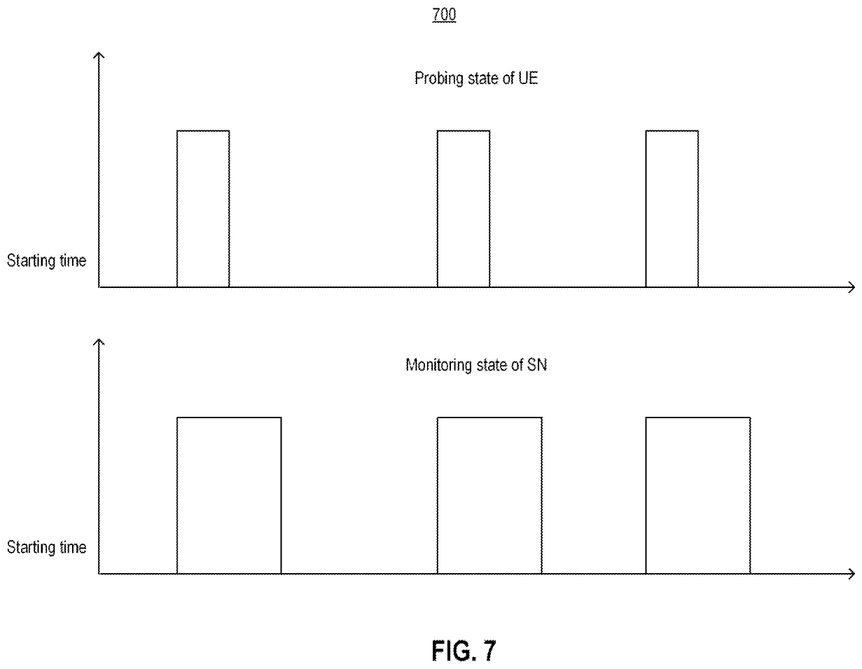

In some implementations, the probing state of the UE 104 can be a subset of the monitoring state of the SN 306. For example, referring to FIG. 7, depicted is a graph 700 of another example of the probing state of the UE 104 and the monitoring state of the SN 306. The time duration of the probing state can be different from the time duration of the monitoring state. In this case, the time duration of the probing state may be less than the monitoring state. Hence, UE 104 in the probing state can transmit at least one signal to the SN 306 (e.g., in the monitoring state with a wider or larger time duration and/or instance than the probing state), such as for activation of one or more forwarding functionalities or links.

For example, if one or more parameters are different, e.g., the duration of probing state for the UE 104 can be a subset of the duration of the monitoring state for the SN 306 because the SN 306 can be used to serve/support multiple UEs 104. The indication or one or more parameters can be provided to the UE 104 via/through the following:
1) Through system information, the one or more parameters can be configured via the system information;
2) Through RRC signal, one or more new RRC parameters can be defined/configured, and/or a value or a set of values can be configured via an RRC message;
3) Through DCI signal, one or more new DCI fields can be defined and/or at least one existing DCI field can be re-interpreted/configured/modified;
4) Through MAC CE signal, at least one new MAC CE can be defined, such as SN monitoring MAC CE signal;
5) Through RRC and DCI signals, at least one set of values for each of the parameters can be configured in the RRC message, and/or at least one of the sets of values can be activated via the DCI signal;
6) Through RRC and MAC CE signals, at least one set of values for each of the parameters can be configured in the RRC message, and/or at least one of the sets of values can be activated by the MAC CE signal; and/or
7) Through RRC, MAC CE, and DCI signals, at least one set of values for each of the parameters can be configured in the RRC message, at least a subset/portion of values can be selected by or according to the MAC CE signal, and/or at least one of the subset of values can be activated via DCI signal.

Further for non-transparent SN 306, when the UE 104 encounters a coverage problem (e.g., via SSB measurement), the UE 104 can determine/decide to active the SN forwarding link or support for signal forwarding by the SN 306. The UE 104 can determine to activate the forwarding link based on at least one of the criteria or coverage problems including at least one of random access failure (e.g., for handover), PUCCH transmission failure, and/or a PUSCH transmission failure occurring for a defined number of times (e.g., N times) (e.g., configured in the specification or system information, among others).

In some cases, the UE 104 can determine to control the on/off status/state of the SN 306 according to the coverage level. The UE 104 can control the on/off state of the SN 306 by transmitting a signal including at least one of a preamble, RS, dedicated sequence, PUCCH, and/or PUSCH to the SN 306 (e.g., during the on/off monitoring state). For example, the UE 104 can initiate a random access procedure, such as for handover. The UE 104 can transmit a signal including a preamble established by the random access procedure. The preamble can include a dedicated resource (e.g., PRACH resource) known by the UE 104 and SN 306 to activate the support for signal forwarding by the SN 306. The dedicated resource can include at least one of: a time domain of a PRACH occasion, a frequency domain resource of the PRACH occasion, and/or a preamble index.

In some cases, the UE 104 can transmit an RS signal including at least one of DMRS, SRS, and/or PTRS. The RS signal can be transmitted with a dedicated port index known by the UE 104 and SN 306, such as to activate the SN 306 (e.g., forwarding link and/or functionality of the SN 306). In some aspects, the UE 104 can transmit the signal including a dedicated signal and/or data sequence (e.g., sometimes referred to as a dedicated sequence). The dedicated sequence can include or correspond to at least one of OOK sequence, CGS, and/or low PAPR sequence. The dedicated sequence can be used to simplify the signal detection, such that the signal detection can be processed in the time domain without additional time-frequency transition operation, for example. In some cases, the signal can include a defined PUCCH transmission known by the UE 104 and the SN 306 to activate the SN 306. In some cases, the signal can include a new or defined MAC CE signal in PUSCH to activate the SN 306.

Accordingly, when the SN 306 receives the signal (e.g., UL signal) including at least one of the preamble, RS, dedicated sequence, PUCCH, and/or PUSCH, among others, the forwarding link of the SN 306 can be enabled/turned on/activated to support signal forwarding capability/functionality for enhancing signal coverage of the UE 104.

Subsequently to activating the SN forwarding link and/or functionality, the SN 306 may report/indicate the SN-UE serving relationship to the BS 102. For example, the SN 306 can send/transmit/signal an indication of the on/off configuration (e.g., including the SN-UE serving relationship), in an uplink control information (UCI) signal via PUCCH or PUSCH, and/or MAC CE signal via or carried by the PUSCH. After the BS 102 receives the on/off configuration report from the SN 306, the BS 102 can transmit/broadcast the system information (SI) to one or more UEs 104, thereby informing the UEs 104 that the SN 306 (e.g., one or more links of the SN 306) is active or turned on. The SI can be transmitted/forwarded from BS 102 directly to at least one UE 104 or via at least one SN 306 (e.g., from BS 102 to SN 306 to UE 104).

In some implementations, the BS 102 can be in an energy-saving mode (e.g., deep sleep or sleep mode). The BS 102 can be in a monitoring state in which the BS 102 may be woken up or activated by the UE 104 (e.g., signal from the UE 104), such that the BS 102 can turn on or revert to a normal or active state/status. The signal from the UE 104 to the BS 102 can be similar to the signal transmitted from the UE 104 to the SN 306 when the UE 104 is in idle, inactive, and/or connected states (e.g., the BS 102 can be non-transparent to UE 104 similar to non-transparent SN). Hence, the relevant signals from one or more UEs 104 can also be used to activate the BS 102, such as in addition to activating the SN 306.

In some implementations, for UE 104 in idle state, the UE 104 can be indicated with at least one of a start time, a pattern, a Start and Length Indicator Value (SLIV), a duty cycle, a time offset, a duration or a periodicity of UE probing state (e.g., sometimes referred to as a triggering state) via a system information (e.g., provided by the BS 102 and/or SN 306). The UE 104 can transmit at least one of a preamble, a msg3, a msgA PUSCH, an RS (e.g., SRS, DMRS, etc.) signal, and/or a (e.g., new) dedicated sequence to the BS 102. For example, the UE 104 can initiate a random access procedure with a dedicated preamble resource (e.g., including at least one of time domain, frequency domain resource of PRACH occasion, and/or preamble index) to activate the BS 102. The UE 104 can transmit the RS signal to the BS 102, which can include at least one of SRS signal and/or DMRS signal. The UE 104 may transmit a dedicated sequence including at least one of OOK sequence, CGS, and/or low PAPR sequence. The dedicated sequence can be used to simplify the signal detection, such as the signal detection can be processed in time domain without additional time-frequency transition operation.

In some implementations, for UE 104 in an inactive state, the UE 104 can be provided with at least one of a start time, a pattern, a Start and Length Indicator Value (SLIV), a duty cycle, a time offset, a duration or a periodicity of UE probing state (e.g., sometimes referred to as a triggering state) via RRC release message, such as when the UE 104 enters the inactive state. The UE may decide to activate the BS 102 by transmitting a signal. The signal can include at least one of a preamble, msg3, msgA PUSCH, RS, SDT, and/or dedicated sequence to the BS 102 (e.g., during the on/off monitoring state). For example, the UE 104 may initiate a random access procedure with a dedicated preamble resource. The dedicated preamble resource can include at least one of time domain resource of PRACH occasion, frequency domain resource of PRACH occasion, and/or preamble index to activate the BS 102. The UE 104 can transmit the RS signal to the BS 102. The RS signal can include at least one of SRS signal and/or DMRS signal. The UE 104 may trigger SDT procedure to transmit CG-SDT and/or RA-SDT (e.g., as part of the signal to the BS 102). The UE 104 can transmit the dedicated sequence including at least one of OOK sequence, CGS, and/or low PAPR sequence. The dedicated sequence can be used to simplify the signal detection, such as the signal detection can be processed in the time domain without additional time-frequency transition operation.

In certain implementations, for UE 104 in connected state, the UE 104 can be provided with at least one of a start time, a pattern, a Start and Length Indicator Value (SLIV), a duty cycle, a time offset, a duration or a periodicity of UE probing state (e.g., sometimes referred to as a triggering state) via at least one of system information, RRC, DCI, and/or MAC CE signals. The parameters for the UE 104 can be similar or different compared with the parameters configured for the BS 102 and/or SN 306. For instance, if different, the duration for the UE 104 may be a subset or a portion of the duration for the BS 102 and/or SN 306 because the BS 102 and/or SN 306 is used to serve multiple UEs 104.

Further, in this case, the UE 104 can determine whether to activate the BS 102 by transmitting a signal to the BS 102 (e.g., during the on/off monitoring state). The signal can include at least one of a preamble, msg3, msgA PUSCH, RS, dedicated sequence, PUCCH, and/or PUSCH. The UE 104 may initiate a random access procedure with a dedicated preamble resource (e.g., including at least one of a time domain resource of PRACH occasion, frequency domain resource of PRACH occasion, or preamble index) to activate the BS 102. The UE 104 may transmit an RS signal including at least one of DMRS, SRS, and/or PTRS with dedicated port index known by the UE 104 and the BS 102 for activating the BS 102. The UE 104 can transmit a dedicated sequence as part of the signal including at least one of OOK sequence, CGS, and/or low PAPR sequence. The dedicated sequence can be used to simplify the signal detection, such that the signal detection can be processed in the time domain without additional time-frequency transition operation. The UE 104 may transmit a PUCCH known by the UE 104 and the BS 102 dedicated to activate the BS 102, for example. In some cases, the UE 104 may transmit a new MAC CE in PUSCH dedicated to activating the BS 102.

In summary, and in various implementations, the UE 104, SN 306, and/or BS 102 can transmit or receive one or more signals between each other to determine, configure, and/or change the on/off state (or configuration) of the SN 306 (e.g., in some cases, the BS 102). The signal can include at least one of: a preamble to configure the UE 104 for initial access, a preamble to configure the UE 104, dedicated to enabling a change to the on/off state of the SN 306, a msg3 or a MsgA PUSCH, an RS (e.g., SRS, DMRS, and/or PTRS, which can be transmitted with a dedicated port index), a configured uplink transmission of a configured grant SDT (CG-SDT), a dedicated PUCCH transmission, a defined MAC CE signal in PUSCH, and/or a dedicated signal or data sequence, among others.

In some implementations, the UE 104 can receive an indication from the BS 102. The indication can include at least one of: a start time, a pattern, a SLIV, a duty cycle, a time offset, a duration, a periodicity, a frequency domain indicator, a frequency offset, a resource block (RB) number, of the time or frequency domain resource of the UE 104. In this case, the UE 104 may be in a probing state (or probing state) configured to send at least one signal to the SN 306. The UE 104 can transmit the signal in the time or frequency domain resource to the SN 306, such as to activate or trigger the SN 306. The UE 104 can receive the indication via at least one of: an SI signal, RRC signal, DCI signal, and/or MAC CE signal.

In various aspects, the UE 104 may determine whether to trigger the SN 306 to support the signal forwarding (e.g., activating or enabling the SN 306) according to at least one of: a measurement of RSRP of an SSB, a random access failure, a physical uplink control channel PUCCH transmission failure, and/or a PUSCH transmission failure occurring for a defined number of times.

In further implementations, the UE 104 can receive a parameter from the BS 102, for instance, for determining whether to enable the functionality (or capability) of sending a signal (e.g., signal sending functionality) to trigger the on/off state of the SN 306. In this case, the UE 104 may be in an idle state, and the SN 306 may be non-transparent to the UE 104.

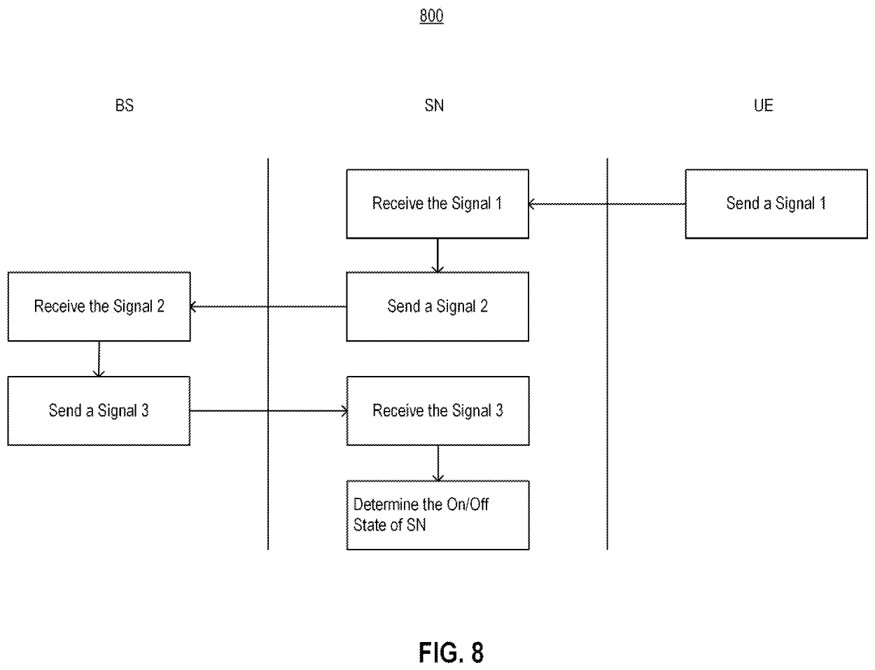

Referring to FIG. 8, depicted is a flow diagram of examples procedures 800 for the SN 306 receiving the signal from the UE 104 and/or the BS 102. The UE 104 can transmit/send/provide a signal to the SN 306. The SN 306 can receive the signal from the UE 104. In some cases, according to the signal from the UE 104, the SN 306 can determine the on/off state (e.g., activation or deactivation) of the SN 306 (e.g., functionality or capability of the SN 306). In this case, the SN 306 can directly determine the on/off state (e.g., corresponding to a forwarding link and/or a forwarding functionality) of the SN 306 in connection with or according to the signal from the UE 104.

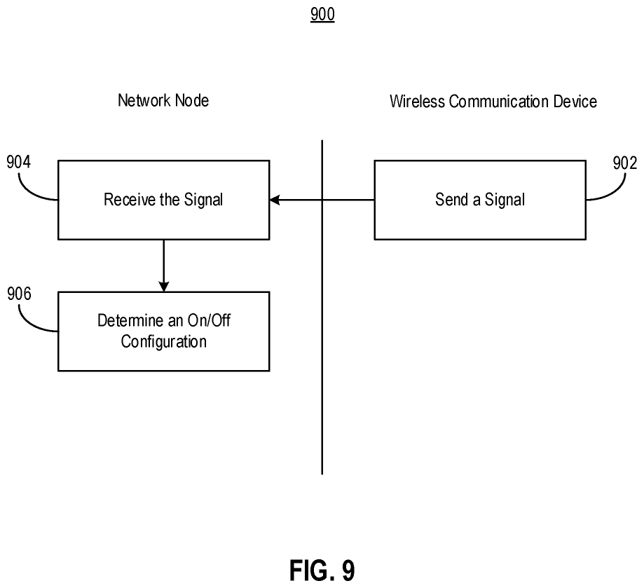

In various implementations, the SN 306 can receive a first signal from the UE 104 (e.g., via a control link). In this case, the SN 306 may not directly determine the on/off state based on the first signal. Instead, the SN 306 may generate and transmit a second signal (e.g., a first message according to the first signal) to the BS 102. The second signal may include data or information similar to the first signal. The second signal may include detection information according to the first signal. The detection information can include at least one of whether to detect the first signal, detected UE numbers (e.g., the number of UEs 104), SINR level (e.g., corresponding to an SINR value or a representative level of SINR value), and/or RSRP level (e.g., corresponding to an RSRP value or a representative level of SINR value). The second signal may be transmitted in a MAC CE or UCI. The BS 102 can receive the second signal. The BS 102 can process the information or indication included in the second signal to determine the on/off state of the SN 306. In response to or subsequent to the determination, the BS 102 can generate and transmit a third signal (e.g., a second message) to the SN 306. The third signal may include an on/off indication to inform SN 306 of, for instance, how to determine the on/off state of SN 306. The on/off indication may include at least one of indication from on to off (e.g., from activation to deactivation), from off to on (e.g., from deactivation to activation), or unchanged (e.g., ignore the indication or maintain the current state of the SN 306). The third signal may be transmitted in DCI, MAC CE, and/or System information (SI). The SN 306 can receive the third signal (e.g., receiving the second message in response to the first message). For example, the third signal can include instructions to activate or deactivate the functionality (or capability or link) of the SN 306. Accordingly, based on or according to the third signal (e.g., second message), the SN 306 can determine the on/off state (e.g., corresponding to a forwarding link and/or a forwarding functionality) of the SN 306. In certain aspects, the one or more implementations described in FIG. 8 can be included or correspond to at least one implementation described in FIG. 9, for example.

In some implementations, the SN 306 can determine the on/off state of the SN 306 as at least one of a switch/change/configuration from on (e.g., on state) to off (e.g., off state) and/or from off to on. For example, the SN 306 can determine to switch from off to on if the signal strength (e.g., RSRP and/or SINR) is greater than (or in some cases equal to) a threshold and/or based on the SN 306 decoding signal from the UE 104. In another example, the SN 306 can determine to switch from on to off if the signal strength is less than (or in some cases equal to) the threshold for a time duration. In this case, if there is no signal or traffic in the network (e.g., for a certain duration or time window), the SN 306 can become inactive, deactivates, or switch off, such as to preserve/save energy. In various aspects, the threshold can be configured, for example, by the BS 102 via at least one of RRC, SI, OAM, MAC CE, and/or DCI signal(s). In various other aspects, the threshold can be predefined/preconfigured/indicated in the specification.

Referring now to FIG. 9 illustrates a flow diagram of a method 900 for UE triggered on/off status control for network nodes. The method 900 may be implemented using any of the components and devices detailed herein in conjunction with FIGS. 1-8. In overview, the method 900 may include sending a signal (902). The method 900 can include receiving the signal (904). The method 900 can include determining an on/off configuration (906).

Referring now to operation (902), and in some implementations, a wireless communication device (e.g., UE) can send/transmit a signal to a network node (e.g., SN). The wireless communication device can send the signal (e.g., while the network node is operating in a monitoring state). By transmitting the signal, the wireless communication device can cause or trigger the network node to determine an on/off configuration (e.g., corresponding to a forwarding link and/or a forwarding functionality) of the network node to support signal forwarding of one or more signals between a wireless communication node (e.g., gNB or BS) and the wireless communication device.

Referring now to operation (904), and in some implementations, the network node can receive the signal from the wireless communication device. For example, the network node can receive the signal directly from the wireless communication device or intercept the signal transmitted by the wireless communication device to ensure proper UL transmission. In some cases, receiving the signal can be interpreted or referred to as, for instance, energy detection, where the network node can detect/identify a signal in a dedicated time and frequency resource. In this case, the RSRP of the signal can be above a threshold, and the network node may not be required to decode the signal or know the information (e.g., radio network temporary identifier (RNTI)) of the wireless communication device. In various aspects, the threshold can be configured, for example, by the wireless communication node via at least one of RRC, SI, OAM, MAC CE, and/or DCI signal(s). In various other aspects, the threshold can be predefined/preconfigured/indicated in the specification. In some cases, receiving the signal can be interpreted as detection and/or decoding. For instance, the network node can decode a signal transmitted by the wireless communication device, such as to the wireless communication node or directly to the network node. In this case, the network node can have the capability of demodulation, decoding of the signal from the wireless communication device, and/or the network node may know information (e.g., RNTI) associated with the wireless communication node.

Referring now to operation (906), and in some implementations, the network node can determine, in connection with the signal, an on/off configuration (e.g., whether to activate the forwarding link and/or forwarding functionality) of the network node to support signal forwarding of one or more signals between the wireless communication node and the wireless communication device.

In some implementations, the network node can determine the on/off state of the network node as at least one of a switch/change/configuration from on (e.g., on state) to off (e.g., off state) and/or from off to on. For example, the network node can determine to switch from off to on if the signal strength (e.g., RSRP and/or SINR) is greater than (or in some cases equal to) a threshold and/or based on the network node decoding signal from the wireless communication device. In another example, the network node can determine to switch from on to off if the signal strength is less than (or in some cases equal to) the threshold for a time duration. In this case, if there is no signal or traffic in the network (e.g., for a certain duration or time window), the network node can become inactive, deactivates, or switch off, such as to preserve/save energy.

In some implementations, to determine the on/off state in connection with the signal, the network node can determine the on/off state using or according to the signal. For example, the network node can receive the signal from the wireless communication device. The network node can directly process (e.g., the network node can include capability for detecting, decoding, and/or demodulating) the signal to determine the on/off state of the network node. In this case, the network node may know the information (e.g., RNTI) of the wireless communication device. In various aspects, additional/further details of this implementation can be described in conjunction with at least FIG. 8.

In various implementations, the network may indirectly process the signal from the wireless communication device to determine the on/off state (or configuration) of the network node. For example, the network node can receive the signal from the wireless communication node. In this case, the network node may detect the signal in a dedicated time and frequency resource, where the RSRP of the signal can be greater than or equal to a threshold. In this case, the network node may not require the information of the wireless communication device and/or to decode the signal. In response to receiving the signal (e.g., preamble), the network node can send/transmit/provide a first message (e.g., status monitoring report) to the wireless communication node according to or based on the signal. The wireless communication node can process the first message from the network node according to the signal to determine the on/off state of the network node. In response to the first message received and processed by the wireless communication node, the network node can receive a second message from the wireless communication node. Accordingly, the network node can (e.g., indirectly) determine the on/off state of the network node according to the second message. In various aspects, additional/further details of this implementation can be described in conjunction with at least FIG. 8.

In some implementations, the network node can receive an indication from the wireless communication node. The indication can include or indicate at least one of: a start time, a pattern, a Start and Length Indicator Value (SLIV), a duty cycle, a time offset, a duration and/or a periodicity of a monitoring state of the network node. For example, an indication for an aperiodic state can include at least one of a start time, duration (e.g., or length), pattern, and/or SLIV. In another example, an indication for a periodic state can include at least one of a start time, duration, periodicity, duty cycle, and/or offset. The network node can operate in the monitoring state to monitor the signal from the wireless communication device. The network node can receive the indication via at least one of: an OAM signal, SI signal, RRC signal, a DCI signal, and/or MAC CE signal.

In various implementations, the network node can receive an indication of at least one of: a start time, a pattern, a SLIV, a duty cycle, a time offset, a duration, a periodicity, a frequency domain indicator, a frequency offset, and/or a resource block (RB) number, of a time or frequency domain resource (e.g., frequency resource indication) of the network node. The network node can monitor the signal from the wireless communication device in the time or frequency domain resource (e.g., specific signals according to the time or frequency domain resource). The indication can be received via at least one of: an OAM signal, an SI signal, an RRC signal, a DCI signal, and/or a MAC CE signal.

In various implementations, the on/off state according to the signal can include at least one of: an on/off state of the network node; an on/off state of a group of network nodes (e.g., multiple SNs); an on/off state of one or more antenna ports of the network node; an on/off state of one or more beam indexes of the network node; an on/off state of one or more serving sectors of the network node; and/or an on/off state of one or more components of the network node, for example, to support signal forwarding for the UE 104.

In some implementations, the on/off state may include the on/off configuration of at least one of the following links: a first control link (e.g., C1 or C2) from the wireless communication node to the network node; a second control link (e.g., the other C2 or C1) from the network node to the wireless communication node; a first backhaul link (e.g., F1 or F2) from the wireless communication node to the network node; a second backhaul link (e.g., the other F2 or F1) from the network node to the wireless communication node; a first access link (e.g., F3 or F4) from the network node to the wireless communication device; and/or a second access link (e.g., the other F4 or F3) from the wireless communication device to the network node.

In various implementations, the wireless communication device can be configured with a probing state (e.g., with a list of one or more parameters/criteria/conditions similar to the monitoring state of the network node). The probing state can be a state in which the wireless communication device can transmit the signal to the network node to control the on/off state of the network node. For example, in this case, the wireless communication device can receive an indication from the network node and/or the wireless communication node. The indication can include or indicate at least one of: a start time, a pattern, a Start and Length Indicator Value (SLIV), a duty cycle, a time offset, a duration, and/or a periodicity, of a probing state (e.g., triggering state) of the wireless communication device. The wireless communication device can operate in the probing state, such as to transmit the signal to the network node. The indication can be received via at least one of: the SI signal, RRC signal, DCI signal, and/or MAC CE signal.

In some implementations, the wireless communication device can receive an indication (e.g., resource or dedicated information to configure the wireless communication device) from the wireless communication node. The indication can include an indication of at least one of: a start time, a pattern, a SLIV, a duty cycle, a time offset, a duration, a periodicity, a frequency domain indicator, a frequency offset, and/or a resource block (RB) number, of the time or frequency domain resource of the wireless communication device. The indication can be received via at least one of: an SI signal, RRC signal, DCI signal, and/or MAC CE signal. The wireless communication device can transmit the signal in the time or frequency domain resource to the network node. In some cases, the wireless communication device can be configured with the dedicated information or resource (e.g., the indication) in any state (e.g., idle, inactive, and/or active state). The wireless communication device may be configured at any time, such as when at least one condition/criterion/parameter (e.g., determination to activate or deactivate the probing state) is met/satisfied.

In some implementations, the wireless communication device can determine whether to trigger (e.g., configure) the network node to support the signal forwarding according to at least one of: a measurement of an RSRP of an SSB, a random access failure, a PUCCH transmission failure, and/or a PUSCH transmission failure occurring for a defined/predetermined/configured number of times. For example, if one or more of the parameters/criteria/conditions (e.g., at least one parameter received from the wireless communication device) are satisfied/met, the wireless communication device can determine to trigger the network node to support the signal forwarding functionality/capability.

In some implementations, the wireless communication device can receive at least one parameter/condition/criterion from the wireless communication node. The wireless communication device can use or determine whether to enable at least one functionality (or capability) of sending a signal to trigger the on/off state of the network node according to the parameter. For example, by satisfying or meeting the parameter, the wireless communication device can determine to enable sending of the signal to trigger the on/off state of the network node. Otherwise, if the parameter is not satisfied, the network node may not enable the sending of the signal, for example.

In some implementations, the wireless communication device can be in an inactive state (e.g., RRC_INACTIVE state) and the network node may be transparent to the wireless communication device. In this case, at least one of the following can occur. For example, the signal (e.g., transmitted from the wireless communication device to the network node) can include a preamble to configure the wireless communication device for initial access (e.g., random access procedure for entering into a connected state, scheduling request (SR), buffer status report (BSR), beam failure recovery, and/or handover), a preamble to configure the wireless communication device, such as dedicated to enabling a change/configuration to the on/off state of the network node, a msg3 or a MsgA physical uplink shared channel (PUSCH), an RS, a configured uplink transmission of a configured grant SDT (CG-SDT), a dedicated/defined PUCCH transmission (e.g., dedicated time or frequency domain resource or dedicated content of the signal), a defined MAC CE signal in PUSCH, and/or a dedicated signal or data sequence. The RS can include at least one of: an SRS, DMRS, and/or PTRS. The RS can be transmitted with at least one dedicated port index. The dedicated PUCCH transmission and/or defined MAC CE signal in PUSCH can be known by the network node and/or wireless communication device for turning on or enabling support for forwarding functionality/capability.

In various implementations, the wireless communication device can be in an inactive state and the network node may be non-transparent to the wireless communication device. In this case, for example, the wireless communication device can receive an indication from the wireless communication node. The indication can include or be an indication of at least one of: a start time, a pattern, a Start and Length Indicator Value (SLIV), a duty cycle, a time offset, a duration, and/or a periodicity, of a probing state of the wireless communication device. The probing state (or triggering state) of the wireless communication device can be configured based on or according to one or more parameters included in the indication, for example. The wireless communication device can operate in the probing state to transmit the signal to the network node. The indication can be received via at least one of: a system information (SI) signal, a radio resource control (RRC) signal, a downlink control information (DCI) signal, or a medium access control control element (MAC CE) signal.

In some implementations, the network node can send/transmit/provide an indication of the on/off state (e.g., SN-UE serving relationship) to the wireless communication node, such as in an uplink control information (UCI) signal via a PUCCH or a PUSCH, and/or in a MAC CE signal via the PUSCH. In certain implementations, the wireless communication node can receive the indication from the network node (e.g., or directly from the wireless communication device). After receiving the indication of the on/off state (or configuration), the wireless communication node can transmit system information directly to at least the wireless communication device (or other wireless communication devices), and/or via the network node to at least the wireless communication device (e.g., indirectly via the network node to the wireless communication device), to indicate that one or more links of the network node is turned on, activated, or enabled.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a network node, a signal from a wireless communication device; and
determining, by the network node in connection with the signal, an on/off state of the network node to support signal forwarding of one or more signals between a wireless communication node and the wireless communication device.

2. The method of claim 1, wherein determining, by the network node in connection with the signal, the on/off state comprises:
determining, by the network node using or according to the signal, the on/off state;
or
sending, by the network node to the wireless communication node, a first message according to the signal;
receiving, by the network node from the wireless communication node, a second message in response to the first message; and
determining, by the network node according to the second message, the on/off state of the network node.

3. The method of claim 1, comprising:
receiving, by the network node from the wireless communication node, an indication of at least one of: a start time, a pattern, a Start and Length Indicator Value (SLIV), a duty cycle, a time offset, a duration or a periodicity, of a monitoring state of the network node; and
operating, by the network node in the monitoring state, to monitor the signal from the wireless communication device,
wherein the indication is received via at least one of: an operations, administration and maintenance (OAM) signal, a system information (SI) signal, a radio resource control (RRC) signal, a downlink control information (DCI) signal, or a medium access control control element (MAC CE) signal.

4. The method of claim 1, comprising:
receiving, by the network node from the wireless communication node, an indication of at least one of: a start time, a pattern, a Start and Length Indicator Value (SLIV), a duty cycle, a time offset, a duration, a periodicity, a frequency domain indicator, a frequency offset, or a resource block (RB) number, of a time or frequency domain resource of the network node; and
monitoring, by the network node in the time or frequency domain resource, to monitor the signal from the wireless communication device,
wherein the indication is received via at least one of: an operations, administration and maintenance (OAM) signal, a system information (SI) signal, a radio resource control (RRC) signal, a downlink control information (DCI) signal, or a medium access control control element (MAC CE) signal.

5. The method of claim 1, wherein the on/off state comprises at least one of:
an on/off state of the network node;
an on/off state of a group of network nodes;
an on/off state of one or more antenna ports of the network node;
an on/off state of one or more beam indexes of the network node;
an on/off state of one or more serving sectors of the network node; or
an on/off state of one or more components of the network node.

6. The method of claim 1, wherein the on/off configuration further comprises the on/off state of at least one of following links:
a first control link from the wireless communication node to the network node;
a second control link from the network node to the wireless communication node;
a first backhaul link from the wireless communication node to the network node;
a second backhaul link from the network node to the wireless communication node;
a first access link from the network node to the wireless communication device; or
a second access link from the wireless communication device to the network node.

7. The method of claim 1, wherein:
the wireless communication device receives from the wireless communication node an indication of at least one of: a start time, a pattern, a Start and Length Indicator Value (SLIV), a duty cycle, a time offset, a duration or a periodicity, of a probing state of the wireless communication device; and
the wireless communication device operates in the probing state, to transmit the signal to the network node,
wherein the indication is received via at least one of: a system information (SI) signal, a radio resource control (RRC) signal, a downlink control information (DCI) signal, or a medium access control control element (MAC CE) signal.

8. The method of claim 1, wherein:
the wireless communication device receives from the wireless communication node an indication of at least one of: a start time, a pattern, a SLIV, a duty cycle, a time offset, a duration, a periodicity, a frequency domain indicator, a frequency offset, a resource block (RB) number, of the time or frequency domain resource of the wireless communication device,
the wireless communication device transmits in the time or frequency domain resource the signal to the network node,
wherein the indication is received via at least one of: a system information (SI) signal, a radio resource control (RRC) signal, a downlink control information (DCI) signal, or a medium access control control element (MAC CE) signal.

9. The method of claim 1, wherein:
the wireless communication device determines whether to trigger the network node to support the signal forwarding according to at least one of:
a measurement of a reference signal received power (RSRP) of a synchronization signal block (SSB),
a random access failure,
a physical uplink control channel (PUCCH) transmission failure, or
a physical uplink shared channel (PUSCH) transmission failure occurring for a defined number of times.

10. The method of claim 1, wherein:
the wireless communication device receives a parameter from the wireless communication node for determining whether to enable a functionality of sending a signal to trigger the on/off state of the network node.

11. The method of claim 1, wherein the signal comprises at least one of:
a preamble to configure the wireless communication device for initial access,
a preamble to configure the wireless communication device, dedicated to enabling a change to the on/off state of the network node,
a msg3 or a MsgA physical uplink shared channel (PUSCH),
a reference signal (RS),
the RS comprises at least one of: a sounding reference signal (SRS), a demodulation reference signal (DMRS), or a phase tracking reference signal (PTRS),
the RS is transmitted with a dedicated port index,
a configured uplink transmission of a configured grant SDT (CG-SDT),
a dedicated PUCCH transmission,
a defined MAC CE signal in PUSCH, or
a dedicated signal or data sequence.

12. The method of claim 1, comprising;
sending, by the network node to the wireless communication node, an indication of the on/off state, in an uplink control information (UCI) signal via a physical uplink control channel (PUCCH) or a physical uplink shared channel (PUSCH), or in a medium access control control element (MAC CE) signal via the PUSCH.

13. The method of claim 12, wherein the wireless communication node, after receiving the indication of the on/off state, transmits system information directly to at least the wireless communication device, or via the network node to at least the wireless communication device, to indicate that one or more links of the network node is turned on.

14. A method comprising:
sending, by a wireless communication device to a network node, a signal,
wherein the network node determines in connection with the signal, an on/off state of the network node to support signal forwarding of one or more signals between a wireless communication node and the wireless communication device.

15. A wireless communication device, comprising:
at least one processor configured to:
send, via a transmitter to a network node, a signal,
wherein the network node determines in connection with the signal, an on/off state of the network node to support signal forwarding of one or more signals between a wireless communication node and the wireless communication device.

16. A network node, comprising:
at least one processor configured to:
receive, via a receiver, a signal from a wireless communication device; and
determine, in connection with the signal, an on/off state of the network node to support signal forwarding of one or more signals between a wireless communication node and the wireless communication device.

17. The network node of claim 16, wherein to determine the on/off state, the at least one processor is configured to:
determine, using or according to the signal, the on/off state;
or
send, via a transmitter to the wireless communication node, a first message according to the signal;
receive, via the receiver from the wireless communication node, a second message in response to the first message; and
determine, according to the second message, the on/off state of the network node.

18. The network node of claim 16, wherein the at least one processor is configured to:
receive, via the receiver from the wireless communication node, an indication of at least one of: a start time, a pattern, a Start and Length Indicator Value (SLIV), a duty cycle, a time offset, a duration or a periodicity, of a monitoring state of the network node; and
operate, in the monitoring state, to monitor the signal from the wireless communication device,
wherein the indication is received via at least one of: an operations, administration and maintenance (OAM) signal, a system information (SI) signal, a radio resource control (RRC) signal, a downlink control information (DCI) signal, or a medium access control control element (MAC CE) signal.

19. The network node of claim 16, wherein the at least one processor is configured to:
receive, via the receiver from the wireless communication node, an indication of at least one of: a start time, a pattern, a Start and Length Indicator Value (SLIV), a duty cycle, a time offset, a duration, a periodicity, a frequency domain indicator, a frequency offset, or a resource block (RB) number, of a time or frequency domain resource of the network node; and
monitor, in the time or frequency domain resource, to monitor the signal from the wireless communication device,
wherein the indication is received via at least one of: an operations, administration and maintenance (OAM) signal, a system information (SI) signal, a radio resource control (RRC) signal, a downlink control information (DCI) signal, or a medium access control control element (MAC CE) signal.

20. The network node of claim 16, wherein the on/off state comprises at least one of:
an on/off state of the network node;
an on/off state of a group of network nodes;
an on/off state of one or more antenna ports of the network node;
an on/off state of one or more beam indexes of the network node;
an on/off state of one or more serving sectors of the network node; or
an on/off state of one or more components of the network node.
